(19) United States
(12) Patent Application Publication
(10) Pub. No.: US 2003/0159043 A1
(43) Pub. Date: Aug. 21, 2003

(54) METHOD AND APPARATUS FOR USE OF A WATERMARK AND A RECEIVER DEPENDENT REFERENCE FOR THE PURPOSE OF COPY PRETECTION

(76) Inventor: MICHAEL A. EPSTEIN, SPRING VALLEY, NY (US)

Correspondence Address: PHILIPS INTELLECTUAL PROPERTY & STANDARDS, P.O. BOX 3001, BRIARCLIFF MANOR, NY, 10510, US

(21) Appl. No.: 09/320,806

(22) Filed: May 27, 1999

(51) Int. Cl. H04L 9/00

(52) U.S. Cl. 713/176; 380/201; 705/57

(57) ABSTRACT

A copyright protection system for protecting content wherein a receiver dependent ticket is calculated at a source device by combining a receiver dependent identifier with a ticket. The receiver dependent identifier is transmitted from the receiver to the source device prior to the source device transmitting watermarked content to the receiver. The receiver dependent identifier is also stored at the receiver. Thereafter, the source device transmits, to the receiver, watermarked content, the ticket, and the receiver dependent ticket. At the receiver, the stored receiver dependent identifier is combined with the ticket in the same way that the receiver dependent identifier is combined with the ticket at the source device. A result of the combination is compared to the receiver dependent ticket and if the result equals the receiver dependent ticket, then the watermark and ticket may be compared in the usual way to determine the copy protection status of the copy protected content.

### FIELD OF THE INVENTION

This invention generally relates to a system for protecting copyrighted content. Specifically, the present invention pertains to utilizing a ticket, a watermark, and a receiver dependent reference to protect content.

### BACKGROUND OF THE INVENTION

The ability to transmit digital information securely is increasingly important. Owners of content want to be able to provide the content to authorize users without having the content utilized by unauthorized users. However, one problem with digital content is that an exact copy can be made without any degradation in the quality of the copy. Therefore, the copying of digital content is very attractive to pirating operations or attackers.

There are several different levels of attackers. Each type of attacker has a different level of sophistication, motivation, and means (software and hardware) needed to defeat a copy protection method. There are four typical types of attackers, a casual attacker, a hacker, a small-scale pirate, and a commercial pirate.

A casual attacker is an ordinary consumer that is motivated to copy content for later use (time shifting) or for distribution to friends and relatives. The level sophistication of a casual attacker is low. The casual attacker will typically only use consumer equipment in an unmodified form. A more aggressive casual attack may be mounted if a relatively inexpensive modification to consumer equipment is available. This may take the form of a hardware device such as the equipment used to defeat the Macrovision system. Typically, a casual attacker will not open a product to access the internal connections.

A hacker is usually motivated to copy protected content just to see if it can be done. The content may then be distributed widely in avoidance or in spite of copy protection laws. An attacker of this type is often highly skilled and may go to great lengths to acquire content. The financial resources of such an attacker are limited but the time resources can be high. Once the content is acquired, the content may be distributed to friends and relatives. In addition, the Internet may also provide an anonymous method for distributing the illegally copied content.

Both small-scale and commercial pirates are interested in defeating copy-protected content in order to produce and sell illegal copies of the content. By avoiding payments to the rightful owner of the copy-protected content, the pirates may reap large profits. Typically, the pirate may take advantage of the difference in release windows in order access high value content and distribute it.

For instance, in the movie industry, release windows are utilized to maximize profit from content. The essence of these release windows is to first release the content to a premium service such as a pay-per-view service or a video on demand service. Thereafter, the content may be released on a lower price service such as a home-box-office service. At this time, the content may also be available to a consumer through a purchased storage medium such as a Digital Video Disc (DVD).

Pirates however, frustrate the use of these release windows by pirating the content that is available through the premium service and then releasing pirated versions of the content to the public. This may cause substantial financial losses to the rightful owners of the content. Accordingly, a successful copy protection scheme should at least frustrate a pirates attempt for a sufficient period of time till the legitimate owner of the content may reap their rightful profits.

As a class, pirates are assumed to have information not readily available to the consumer including a direct knowledge and understanding of the circuitry within a product. Additionally, the pirate is willing to open the cover of the device to gain access to internal connections. These connections can be easily accessible or may take some amount of specialized tooling to locate or tap. A pirate may have the ability to reverse engineer a product sufficiently to determine the location of clear digital signals. A pirate may also have detailed information about internal circuitry of consumer electronics devices that would allow for the tapping of clear digital signals before or after compression. The pirate typically has the understanding needed to use expensive custom hardware that is designed to break cryptographic keys. Finally, the pirate is assumed to have knowledge of the algorithms and protocols used within the copy protection system and some ability to attempt to defeat them. The systems used to defeat copy protection may include a PC, a group of PCs, or custom-built equipment assembled for the sole purpose of defeating copy protection.

Beyond some level of attacker, the expense of defeating the attacker exceeds a reasonable limit whereby the device must be priced beyond what consumer is willing to pay. Thus, a copy protection solution must be cost effective but secure against a large number of attackers.

A cost-effective method of copy protection is discussed in detail by Jean-Paul Linnartz et al., in Philips Electronics Response to Call for Proposals Issued by the Data Hiding Subgroup Copy Protection Technical Working Group, July 1997 (“Linnartz”), which is incorporated herein by reference. Within a digital transmission, such as an MPEG transport stream, additional data may be embedded within the transport stream to set the copy protection status of content contained within the digital transmission. For instance, the desired copy protection status may be “copy-once”, “no-more-copy”, “copy-never”, and “copy-freely”. Content that has a status of copy-once may be played and copied. During copying, the copy-once content is altered such that the content is in the no-more-copy state. Copy-never content is content that may only be played and may not be copied. Copy-freely content may be played and copied without restriction.

The additional data may take the form of a digital watermark. The watermark may be embedded directly into the content so that removal of the watermark will degrade the quality of the content. The watermark may be utilized as part of the copy protection scheme. As an example, the copy-freely state may be designated by the lack of a watermark within the content.

In operation, a transmission, such as a digital transmission, is sent from a source device and received by a receiving device. A source device is a device that is writing content onto a data bus, initiating a broadcast transmission, initiating a terrestrial transmission, etc. A sink device is a device that reads content from the data bus, etc.

FIG. 1 shows a typical system for the transmission of content. In FIG. 1, the source device is a broadcast initiator 101 that utilizes a transmitting antenna 102 to transmit content. The sink device is a broadcast receiver, such as a set-top-box (STB) 104 that utilizes a receiving antenna 103 for receiving the transmitted content. The STB 104 is shown connected to a display device 105, a player 106, and a player/recorder 107, through a bus 108. The term bus is utilized herein to refer to any system for connecting one device to another device. The bus may be a hard wired system such as a coaxial wire, an IEEE 1553 bus, etc., or the bus may be a wireless system such as an infra-red (IR) or radio frequency (RF) broadcast system. Several of the devices shown in FIG. 1 may at one time act as a source device and at another time act as a sink device. The STB 104 may be a sink for the broadcast transmission and be a source for a transmission on the bus 108. The player/recorder 107 may be a source/sink of a transmission to/from, respectively, the bus 108.

In the copy protection scheme discussed by Linnartz, a watermark (W) is embedded within transmitted content. A ticket is transmitted along with the transmitted content. The embedded watermark and the ticket together are utilized to determine the copy protection status of the transmitted content. The watermark may be embedded into the content by at least two known methods. One method embeds the watermark (W) in the MPEG coding of the content. Another method embeds the watermark (W) in the pixel data of the content. The ticket (T) is mathematically related to the watermark (W) as discussed in more detail below.

Performing one or more one-way functions on the ticket (T) derives the watermark (W). By use of the term one-way function, what is meant is that it is computationally unfeasible to compute the inverse of the function. An example of a publicly known mathematical one-way function is a hashing function, such as secure hash algorithm one (SHA-1) or RACE Integrity Primitives Evaluation Message Digest (RIPEMD). Computing an inverse means finding which particular x₀ leads to a given y₀ with y₀=F(x₀) The term unfeasible is intended to mean that the best method will take too long to be useful for a pirate. For instance, the time that is required for a pirate to compute the inverse of a hashing function is too long for the pirate to frustrate the intended release window for protected content. The most efficient method known to find such an x₀ may be to exhaustively search all possible bit combinations of x₀ and to compute and verify F(x₀) for each attempt. In other cases, there may be a more efficient method than an exhaustive search to compute an inverse of a one-way function, yet these methods are still too time consuming to be feasible for the pirate.

The bit content of the ticket (T) is generated from a seed (U). The content owner provides the seed (U). From the seed (U), a physical mark (P) is created. The physical mark (P) may be embedded on a storage medium such as a Read-Only Memory (ROM) disk. Performing one or more one-way functions on the physical mark (P), produces the ticket (T). The number of functions performed on the physical mark (P) to create the ticket (T) depends on the copy protection intended for the content.

In accordance with the system, the ticket (T) changes state during every passage of a playback device (e.g., a source device) and a recording device (e.g., a sink device). As discussed above, the state modifications are mathematically irreversible and reduce the remaining copy and play rights of the content that are granted by the ticket (T). In this way, the ticket (T) indicates the number of sequential playback and recordings that may still be performed and acts as a cryptographic counter that can be decremented but not incremented.

It should be noted that the copy protection scheme only protects content on compliant systems. A compliant system is any system that obeys the copy protection rules described above and hereinafter. A non-compliant system may be able to play and copy material irrespective of the copy protection rules. However, a compliant system should refuse to play copies of content illegally made on a non-compliant system.

In accordance with the copy protection scheme, a physical mark (P) (e.g., data) is embedded on a storage medium and is not accessible by other user equipment. The physical mark (P) data is generated at the time of manufacturing of the storage medium as described above and is attached to the storage medium in a way in which it is difficult to remove the physical mark (P) data without destroying the storage medium. For instance, the application of a one-way mathematical function, such as a hashing function, to the physical mark (P) data one time or four times, depending upon copy rights, results in a watermark. Much like watermarks embedded in paper, the watermark is embedded in the medium (e.g., containing video, audio, or data) in such a way that it is infeasible to remove the watermark without destroying the material. At the same time the watermark should be imperceptible when the medium is used in the usual manner, such as when content from the medium is displayed.

A watermark by itself may indicate whether or not content stored on the storage medium is copy-once or copy-never. For instance, the absence of a watermark may indicate that the content may be copied freely. The presence of the watermark without a ticket on a storage medium may indicate copy-never content.

When a compliant recorder reads the content, the watermark is checked to see if the material is copy-freely, copy-once, or copy-never. When there is no watermark, the content is copy-freely and may be copied freely as discussed above. When the content contains a watermark but no ticket, the content is copy-never and a compliant recorder will refuse to copy the content. When the content is copy-once, the content contains both a watermark and a ticket, a compliant recorder will hash the ticket twice and compare the twice-hashed ticket to the watermark. In the case where the watermark matches the twice-hashed ticket, the content may be recorded along with a once-hashed ticket and the watermark, thereby creating copy-no-more content (e.g., content with a once-hashed ticket and a watermark). The physical mark will be different on a writable disc and thus, even if an illegal copy is made of copy-never content via a non-compliant recording device, a compliant player will refuse to play the content recorded on the writable disc.

It should be noted that in a broadcast system, such as a pay-per-view system, a copy-never state may be indicated by the presence of a once-hashed ticket and a watermark. Both copy-no-more stored content and copy-never broadcast content are treated by a compliant system similarly. The content containing the once-hashed ticket may be played but may not be recorded in a compliant system. In the event that a party tries to record the content with the once-hashed ticket, a compliant recorder will first twice-hash the once-hashed ticket and compare the result (e.g., a thrice-hashed ticket) with the watermark. Since the thrice-hashed ticket will not match the watermark, the compliant recorder will refuse to record the content.

However, a problem exists wherein a non-compliant recorder receives content containing a ticket (a twice-hashed physical mark) and a watermark. In the event that a non-compliant recorder does not alter the ticket upon receipt or recording (e.g., the non-compliant recorder makes a bit-for-bit copy), the non-compliant recorder may make multiple copies of the ticket and the watermark that may be recorded on a compliant recorder. The same problem can exist where a non-compliant recorder receives content containing a once-hashed ticket (a thrice-hashed physical mark) and a watermark indicating copy-no-more content. In this case, the non-compliant recorder may make multiple copies of the once-hashed ticket and the watermark that will play on the compliant player.

In a case wherein the player receives the content directly from a read only medium, such as a Compact Disc ROM (CD-ROM), a physical mark can be embedded in the physical medium of the CD-ROM that is produced by an authorized manufacturer. The player may then check the physical mark to ensure that the content is being received from an authorized medium. In this way, if a pirate makes an unauthorized copy, the physical mark will not be present on the unauthorized copy and a compliant player will refuse to play the content. However, in the case of broadcast data for instance, wherein a player does not read content directly from the read-only medium, this method of copy protection is unavailable. Thus, for instance, a non-compliant player may deceive a compliant display device.

Accordingly, it is an object of the present invention to overcome the disadvantages of the prior art.

It is also an object of the present invention to provide a output device, such as a display device or an audio output device, that is the final arbiter in deciding whether to display copy protected content. Accordingly, the display device, etc. is the gatekeeper that disallows recordings that are made and played back on non-compliant player/recorders.

It is a further object of the present invention to provide a method of transmitting copy protected copy-never content that will prevent a pirate from making copies that will display, play, etc. on a compliant display device, etc.

It is still a further object of the present invention to create a ticket that is unique to a particular display device, etc. so that copy protected content will only play on the particular display device, etc.

### SUMMARY OF THE INVENTION

These and other objects of the present invention are achieved by a copy protection system for protecting content, such as content containing a watermark embedded therein (e.g., watermarked content). In accordance with the present invention, a receiver dependent ticket is created at a source device preferably utilizing a receiver dependent reference. In accordance with one embodiment of the present invention, the receiver dependent reference is combined with a ticket utilizing a concatenation function and a one-way function (e.g., a hashing function). The receiver dependent reference is transmitted from a receiver, such as a display device, an audio output device, a data output device, etc., to the source device prior to the source device transmitting watermarked content to the receiver. The receiver dependent reference is also stored at the receiver. Thereafter, the source device transmits to the receiver watermarked content, the ticket, and the receiver dependent ticket.

At the receiver, the ticket is hashed twice and compared to the watermark in the usual way. In the event that the twice-hashed ticket compares to the watermark (W=H(H(T))), the stored receiver dependent identifier is combined with the ticket in the same way that the receiver dependent identifier was combined with the ticket at the source device. A result of the combination is compared to the receiver dependent ticket. If the result equals the receiver dependent ticket, then the receiver is provided with access (e.g., enabled to display) to the watermarked content.

In one embodiment, the receiver dependent identifier may be a fixed receiver serial number. The serial number may be stored in a memory of the receiver or it may be a serial number, or a portion of a serial number from a component within the receiver, such as a processor serial number. In yet another embodiment, a certificate containing the public key of the source device is sent to the receiver prior to the above described process. A public key known to the receiver may be used to verify the certificate. The manufacturer should build (e.g., store) the public key used to verify the certificate into the receiver as is known in the art. In this embodiment, the receiver dependent ticket (the receiver dependent identifier concatenated with the ticket) may be encrypted utilizing a private key of the source device. The encrypted receiver dependent ticket is then transmitted from the source device to the receiver along with the watermarked content and the ticket. Thereafter, prior to the receiver verifying the receiver dependent ticket, the receiver decrypts the receiver dependent ticket utilizing a public key of the source device.

In still yet another embodiment, the receiver dependent ticket may be signed (as is know in the art, by hashing the receiver dependent ticket and encrypting that hashed result) utilizing a private key of the source device. The resulting signature is sent along with the watermarked content, the receiver dependent ticket, and the ticket to the receiver along with the watermarked content. Thereafter, prior to the receiver verifying the unique receiver identifier, the receiver verifies the signature on the receiver dependent ticket utilizing a public key of the source device.

### BRIEF DESCRIPTION OF THE DRAWINGS

The following are descriptions of embodiments of the present invention that when taken in conjunction with the following drawings will demonstrate the above noted features and advantages, as well as further ones. It should be expressly understood that the drawings are included for illustrative purposes and do not represent the scope of a present invention. The invention is best understood in conjunction with the accompanying drawings in which:

FIG. 1 shows a conventional system for the transmission of content;

FIG. 2 shows an illustrative communication network in accordance with an embodiment of the present invention;

FIG. 3 shows details of an illustrative communication network in accordance with embodiment of the present invention wherein a source device provides content to a sink device; and

FIG. 4 shows a flow diagram in accordance with an embodiment of the present invention wherein a serial number is utilized as a unique receiver identifier and a private/public key system is utilized to further secure the receiver dependent ticket.

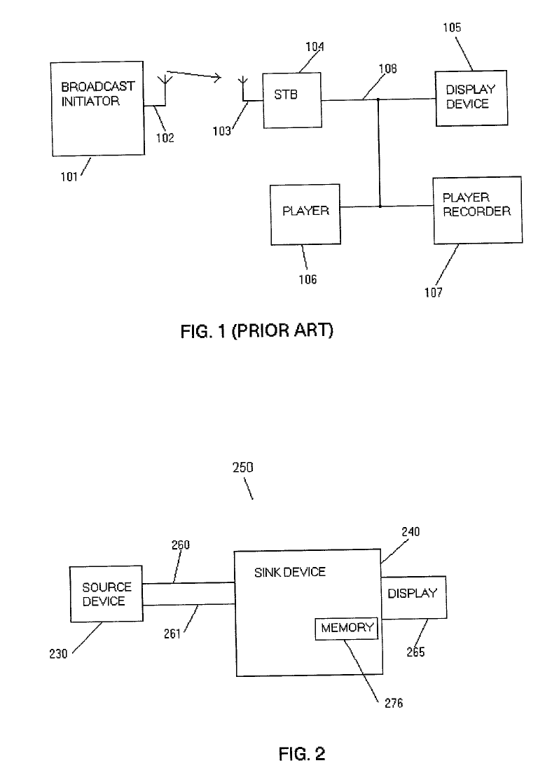

### DETAILED DESCRIPTION OF THE INVENTION

FIG. 2 depicts an illustrative communication network 250 in accordance with an embodiment of the present invention. A source device 230, such as Set Top Box (STB), a Digital Video Disc (DVD), a Digital Video Cassette Recorder (DVCR), or another source of content, utilizes a transmission channel 260 to transmit content to a sink device 240. The transmission channel 260 may be a telephone network, a cable television network, a computer data network, a terrestrial broadcast system, a direct broadcast satellite network, some combination thereof, or some other suitable transmission system that is know in the art. As such, the transmission channel 260 may include RF transmitters, satellite transponders, optical fibers, coaxial cables, unshielded twisted pairs of wire, switches, in-line amplifiers, etc. The transmission channel 260 may also operate as a bi-directional transmission channel wherein signals may be transmitted from/to the source device 230, respectively, to/from the sink device 240. An additional transmission channel 261 may also be utilized between the source device 230 and the sink device 240. Typically, the transmission channel 260 is a wide-bandwidth channel that in addition to transmitting copy protection content (e.g., copy protection related messages), transmits copy protected content. The transmission channel 261 typically is a low-bandwidth channel that is utilized to transmit copy protection messages.

The sink device 240 contains a memory 276 that is utilized for storing a receiver dependent identifier. The memory 276 is a non-volatile storage, such as a programmable read-only memory (PROM), an electrically erasable PROM (EEPROM), a hard-wired electrical circuit, etc.

The receiver dependent identifier, in accordance with the present invention, is transmitted to the source device 230 utilizing at least one of the transmission channels 260, 261. The source device 230 utilizes the receiver dependent identifier to change the ticket such that the watermarked content may only be utilized (e.g., played) by a corresponding sink device as described in more detail below. In the event that the corresponding sink device, such as the sink device 240, receives the watermarked content, then the content may be provided to a device, such as a display device 265, for display thereon. Preferably, the display device 265 is integral to the sink device 240 such that the display device 265 is the final arbiter in determining whether the copy protected content may be utilized. It should be obvious that although the device is illustratively shown as the display device 265, in fact the device may be any known device that may be suitably utilized for the copy protected content. For instance, in a case wherein the copy protected content is audio content, the device may be the device that outputs the audio signal. In other embodiments, the device may be any suitable device for manipulating the content that may include, video, audio, data, etc., or some combination thereof.

In one embodiment of the present invention, the content may be provided from the source device 230 in the form of a Moving Picture Experts Group (MPEG) compliant transport stream, such as an MPEG-2 compliant transport stream. However, the present invention is not limited to the protection of an MPEP-2 compliant transport stream. As a person skilled in the art would readily appreciate, the present invention may be suitably employed with any other data stream that is known in the art for transmitting content.

In another embodiment, the source device 230 may be a conditional access (CA) device. In this embodiment, the transmission channel 260 is a conditional access module bus.

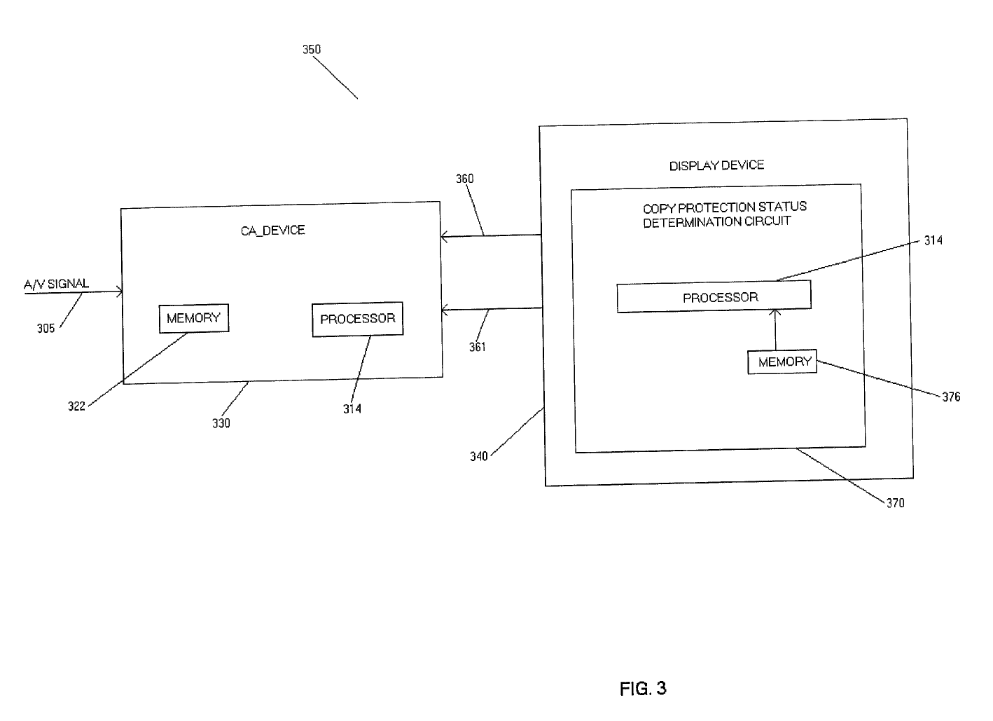

FIG. 3 depicts details of an illustrative communication network 350 in accordance with an embodiment of the present invention. In the communication network 350, a source device 330 provides content, including copy protected content, to a sink device 340, over a transmission channel 360. As discussed above with regard to the transmission channel 260, the transmission channel 360 may be a wide bandwidth transmission channel that may also have a bi-directional capability, such as a CA module bus.

The sink device 340 contains a copy protection status determination circuit 370 for creating/storing a unique receiver identifier and for determining the copy protection status of received content. It should be noted that the term unique as utilized herein is not necessarily intended to denote unique in an absolute sense. It is sufficient that there is a pool of numbers of sufficient size (e.g., the integers between 0 and 2\hat{ }129), that the likelihood of a random selection of a particular one of the numbers is sufficiently small for a given application. Of a course, a smaller or larger pool of numbers may suffice for any particular application.

The copy protection status determination circuit 370 contains a memory device 376 for storing a unique receiver identifier. In operation, the source device 330 may request the unique receiver identifier from the sink device 340 prior to transmitting copy protected content. In alternate embodiments, the sink device 340 may transmit the unique receiver identifier to the source device 330 as a portion of a request for the source device 330 to begin transmission of copy protected content to the sink device 340. The sink device 340 may utilize either of the transmission channels 360, 361 for transmission of the request for copy protected content and/or for transmission of the unique receiver identifier. However, in some embodiments of the present invention, the transmission channel 360 may be unidirectional and may only be utilized for the transmission of content to the sink device 340 from the source device 330. In these embodiments, the transmission channel 361 is utilized for the transmission of the unique receiver identifier from the sink device 340 to the source device 330. The transmission channel 361 may also be utilized for transmitting a request for copy protected content from the sink device 340 to the source device 330.

In an alternate embodiment, the transmission channel 360 has bi-directional capability and may be utilized for transmissions both to and from the source device 330, and to and from the sink device 340. In this embodiment, the transmission channel 361 may not be present or it may be utilized solely for the transmission of content requiring low bandwidth. For instance, the source device 330 may transmit to the sink device 340 a request for the transmission of the unique receiver identifier.

In one particular embodiment, the source device 330 is a conditional access (CA) device 330, the transmission channel 360 is a CA module bus 360, and the sink device 340 is a display device 340. Prior to the transmission of copy protected content, the CA device 330 transmits a request for a unique receiver identifier (e.g., a receiver serial number (S)) from the display device 340. In response to the request, the display device 340 transmits a unique serial number (S), that is stored in a memory 376, to the CA device 330 over the CA module bus 360. It should be readily appreciated that although the serial number (S) is illustratively shown as stored in a memory, in fact, the serial number (S) may be stored or resident in any portion of the display device 340. For instance, the serial number (S) may be a serial number of a processor, such as processor 314 (discussed in more detail below), the serial number (S) may be a fixed hardware configuration that may be interrogated by the processor 314, or the serial number (S) may be any other unique display device identifier that may be known in the art. Importantly, the serial number (S) should be unique (as discussed above) to a given display device, such as display device 340, such that the likelihood is high that another randomly selected display device has a different unique serial number.

The processor 314 utilizes a ticket and the serial number (S), received from the display device 340, to create a receiver dependent ticket (RDT) as discussed in more detail below. In one embodiment, the processor 314 may simply be a fixed hardware device that is configured for performing functions, such as mathematical functions, including a concatenation function, a one-way function, such as a hashing function. In alternate embodiments, the processor 314 may be a microprocessor or a reconfigurable hardware device.

In one embodiment, the copy protected content is received via an input 305 as an audio/video (A/V) signal. Preferably, in this embodiment, the A/V signal contains a watermark (W) and a ticket (T). The watermark (W) and the ticket (T) are related as discussed with regard to the prior art (e.g., W=H(H(T))). Preferably, the watermark (W) is embedded into the copy protected content. In this way, removal of the watermark (W) from the copy protected content will result in the copy protected content becoming largely degraded. In a preferred embodiment, the ticket accompanies the content. However, in alternate embodiments the ticket may also be embedded into the watermarked content without affecting the inventive features of the present invention.

In an alternate embodiment, the copy protected content is read from a physical medium, such as a digital video disc (DVD). In this embodiment, the DVD may contain a physical mark (P) as described Linnartz. Further, content contained on the DVD (e.g., A/V content) typically has a watermark (W) embedded therein (e.g., watermarked content) such that removal of the watermark (W) from the A/V content results in the A/V content becoming largely degraded. In this embodiment, for example when the A/V content is copy-once, the physical mark (P), the ticket (T), and the watermark (W) on the disk are related as follows:

T=H(H(P)) (1)

W=H(H(T)) (2)

In any event, at the CA device 330, the serial number (S) is combined with the ticket (T), utilizing for instance concatenation and hashing functions, thereby creating a receiver dependent ticket (RDT) as follows:

RDT=H(T.S) (3)

The watermarked content, containing a watermark (W) embedded therein, the receiver dependent ticket (RDT), and the ticket (T), are then transmitted via the CA module bus 360 to the display device 340.

At the receiver 340, the copy protection status determination circuit 370 extracts the watermark (W) from the watermarked content. The copy protection status determination circuit 370 compares the watermark (W) and the ticket (T) in the usual way, as is known in the art (e.g., W=H(H(T))?).

In the event that the comparison does not pass (e.g., W H(H(T)), then the content is discarded and any selected operation at the display device 340 (e.g., display) regarding the content is disabled. However, if the comparison does pass (e.g., W=H(H(T))), then the copy protection determination circuit 370 retrieves the serial number (S) from the memory 376 (or from any other suitable location as discussed above) and combines the ticket (T) with the serial number (S), utilizing the same operation that was utilized at the source device 330 for creating the receiver dependent ticket (RDT). For instance, concatenation and hashing functions may be utilized at the display device 340 for combining the ticket (T) with the serial number (S). A result of the combination is then compared to the receiver dependent ticket (RDT):

H(T.C)=RDT? (4)

In the event that the result does not equal the receiver dependent ticket (RDT), then the content is discarded and any selected operation at the display device 340 (e.g., play, record, etc.) regarding the content is disabled. This may happen, for instance, in a case wherein an improper display device (e.g., a display device other than the display device that requested the content) has received the content. If the result does equal the receiver dependent ticket (RDT), then access to the content is enabled in accordance with the access granted by the ticket.

It should be clear that a trusted source should be utilized to create the recorded content or the real time transmitted content (e.g., received over the input 305). A CA device, such as the CA device 330, which is inherently designed to be tamper resistant is an example of a trusted real time source. However, any trusted source that is known in the art may be suitably utilized. In the case of the CA device 330, it may be assumed that the CA device 330 decrypts the watermarked content so that prior to the arrival of the watermarked content at the CA device 330, the watermarked content cannot be recorded.

In a case wherein the ticket (T) does not properly compare to the watermark (W), or some other portion of the copy protection status determination process fails, the copy protected content is discarded. In addition, when the copy protection status determination process fails, no operation regarding the copy protected content is enabled at the display device 340.

In yet another embodiment, a private/public key system, as is known by a person of ordinary skill in the art, is utilized to further secure the copy protected content in accordance with the present invention. In accordance with this embodiment, the display device 340 has a public key that is trusted, e.g., secure for example by being installed in part of the display device 340 hardware, such as stored in the memory 376. The public key corresponds to a private key of the manufacturer of the display device 340. The private key is stored, for instance, in a memory 322 at the CA device 330. The private key is utilized to sign certificates of each CA device manufacturer, as is known in the art.

In operation, when the CA device 330 is connected to the display device 340 via the CA module bus 360, a certificate containing the CA device 330 public key is sent to the display device 340. Once the certificate containing the public key of the CA device 330 is verified by the display device 340, as is known in the art, the public key of this CA device is stored at the display device 340. Thereafter, the CA device 330 may digitally sign the receiver dependent ticket (RDT). For instance, a signature may be calculated by hashing the receiver dependent ticket (RDT) and encrypting the result utilizing the private key of the CA device 330. The signature is sent from the CA device 330 to the display device 340 together with the watermarked content, the ticket, and the receiver dependent ticket (RDT). At the display device 340, the signature is verified utilizing the public key of the CA device 330. Thereafter, the watermarked content, the ticket, the receiver dependent ticket (RDT), and the serial number (S) are utilized as described above.

In yet another embodiment, the receiver dependent ticket (RDT) may be encrypted utilizing the private key of the CA device 330. The encrypted receiver dependent ticket (RDT) is then transmitted from the CA device 330 to the display device 340 along with the watermarked content and the ticket (T). Thereafter, prior to the display device 340 verifying the serial number (S), the display device 340 decrypts the receiver dependent ticket (RDT) utilizing the public key of the CA device 330. Thereafter, the receiver dependent ticket (RDT) may be utilized as discussed above.

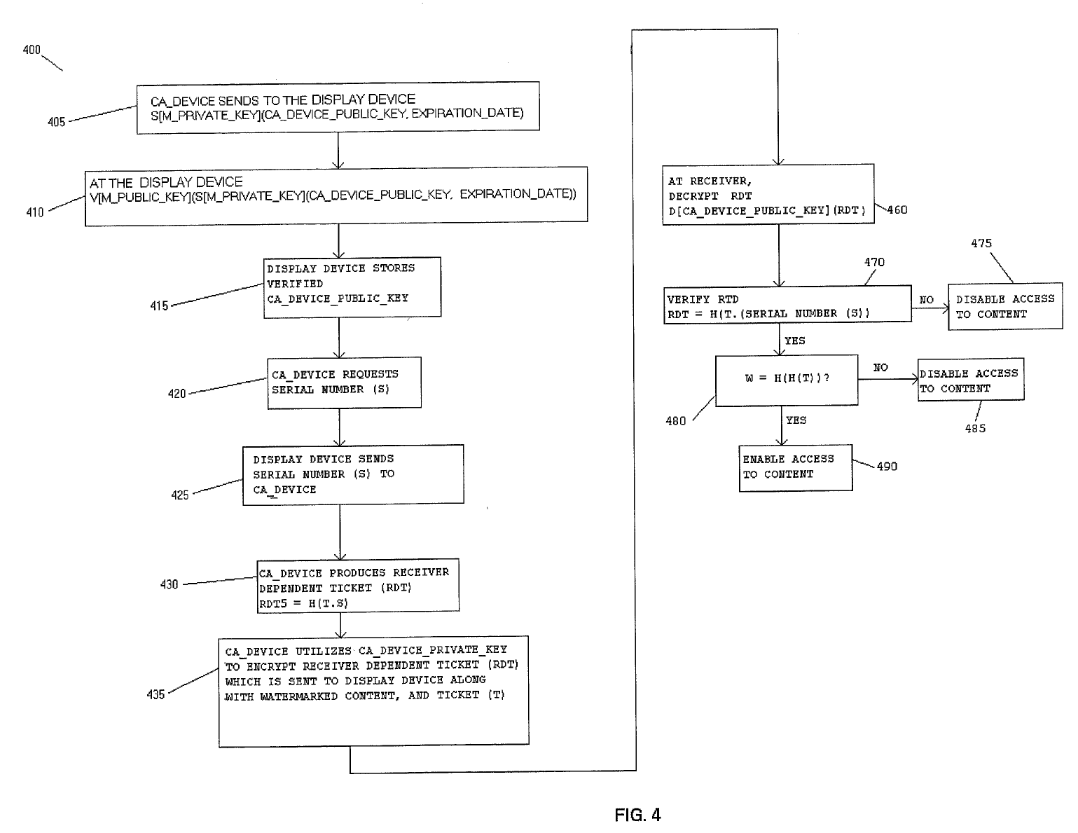

FIG. 4 shows a flow diagram 400 of an illustrative protocol for use of a serial number (S) and a private/public key system in accordance with an embodiment of the present invention. In step 405, in accordance with the present invention, after a CA device is connected to a receiver, the CA device sends a certificate containing the CA device public key to the display device. In some applications, an expiration date may also be attached to the certificate, although the use of an expiration date may not be practical in a consumer environment, where there is often no way to upgrade the certificate.

In step 410, the display device verifies the certificate utilizing the embedded public key of the manufacturer and in step 415, stores the verified public key of the CA device. In step 420, in response to a request for copy protected content from the display device, the CA device requests a serial number (S) (the unique receiver identifier) from the display device. In step 425, the display device sends the serial number (S) to the CA device. In step 430, the CA device combines the serial number (S) with the ticket (T) utilizing concatenation and hashing functions to produce a receiver dependent ticket (RDT). In step 435, the CA device encrypts the receiver dependent ticket (RDT) utilizing the CA device private key. The encrypted receiver dependent ticket (RDT) is then sent to the display device along with the watermarked content and the ticket (T). In step 460, the display device utilizes the public key of the CA device to decrypt the receiver dependent ticket (RDT). In step 470, the display device combines the ticket (T) with the serial number (S) utilizing concatenation and hashing functions and compares a result to the receiver dependent ticket (RDT). If the result is not equal to the receiver dependent ticket (RDT), then in step 475 access to the content is disabled. If the result is equal to the receiver dependent ticket (RDT), then in step 480, the ticket and watermark are compared in the usual way. If step 480 fails (e.g., W≠H(H(T))), then in step 485, access to the content is disabled. If step 480 passes (e.g., W=H(H(T))), then in step 490, access to the content is enabled (e.g., the content may be displayed).

Finally, the above-discussion is intended to be merely illustrative of the invention. Numerous alternative embodiments may be devised by those having ordinary skill in the art without departing from the spirit and scope of the following claims.

claims the claimed invention is:

1. A method of protecting content transmitted as a stream of data, the method comprising the steps of:
determining a unique receiver identifier at a receiving device;
calculating, at a source device, a receiver dependent ticket utilizing the unique receiver identifier, wherein a watermark, a ticket, and the receiver dependent ticket together indicate a copy protection status of the content;
transmitting said stream of data, said watermark, said ticket, and said receiver dependent ticket to said receiving device; and
comparing said receiver dependent ticket to a stored receiver identifier at said receiving device.

2. The method of claim 1, wherein said step of calculating said receiver dependent identifier comprises the steps of:
combining said unique receiver identifier with said ticket, and
calculating a one-way operation on said combined unique receiver identifier and ticket.

3. The method of claim 2, further comprising the step of selecting said one-way function to be a hashing function.

4. The method of claim 1, further comprising the step of comparing, at said receiving device, said ticket and said watermark to determine the copy protection status of the content if said receiver dependent ticket compares to said stored receiver identifier.

5. The method of claim 1, wherein said step of calculating said receiver dependent ticket further comprises the step of encrypting said receiver dependent ticket with a private key of said source device, and wherein said step of comparing said receiver dependent ticket further comprises the step of decrypting said receiver dependent ticket using a public key of said source device.

6. The method of claim 1, wherein said step of calculating said receiver dependent ticket further comprises the step of signing said receiver dependent ticket with a private key of said source device, and wherein said step of comparing said receiver dependent ticket further comprises the step of verifying the signature using a public key of said source device.

7. The method of claim 2, wherein said step of calculating said receiver dependent ticket further comprises the step of encrypting said receiver dependent ticket with a private key of said source device, and wherein said step of comparing said receiver dependent ticket further comprises the step of decrypting said receiver dependent ticket using a public key of said source device.

8. The method of claim 2, wherein said step of calculating said receiver dependent ticket further comprises the step of signing said receiver dependent ticket with a private key of said source device, and wherein said step of comparing said receiver dependent ticket further comprises the step of verifying the signature using a public key of said source device.

9. A copy protection system for protecting content wherein a ticket and a watermark indicates a copy protection status of said content, the system comprising:
a source device configured to calculate a receiver dependent ticket using a unique receiver identifier and a one-way function, and to provide a data stream containing said content, said ticket, a watermark, and said receiver dependent ticket; and
a display device configured to produce said unique receiver identifier, configured to receive said data stream, and configured to compare said receiver dependent ticket to said unique receiver identifier using said ticket and said one-way function.

10. The system of claim 9, wherein said one-way function is a hashing function.

11. The system of claim 9, wherein said source device is further configured to calculate said receiver dependent ticket by combining said unique receiver identifier with said ticket, and then calculating a one-way operation on said combined unique receiver identifier and ticket.

12. The system of claim 9, wherein said display device is further configured to compare said ticket to said watermark and to display said content if said receiver dependent ticket compares to said unique receiver identifier.

13. The system of claim 9, wherein if said receiver dependent ticket equals said unique receiver identifier, said display device is further configured to compare said ticket to said watermark and to produce a signal indicating the copy protection status of the content.

14. The system of claim 9, wherein said unique receiver identifier is a display device serial number.

15. The system of claim 9, wherein said source device is further configured to encrypt said receiver dependent ticket with a private key of said source device and to provide said receiver dependent ticket to said display device as said encrypted receiver dependent ticket, and wherein said display device is further configured to decrypt said encrypted receiver dependent using a public key of said source device.

16. The system of claim 9, wherein said source device is further configured to sign said receiver dependent ticket with a private key of said source device and to provide said signed receiver dependent ticket to said display device, and wherein said display device is further configured to verify the signed receiver dependent ticket using a public key of said source device.

17. A source device for protecting content wherein a ticket and a watermark indicate a copy protection status of the content, said source device comprising:
a reader device configured to read watermarked content from a physical medium and configured to read a physical mark from said physical medium; and
a processor configured to receive a unique receiver identifier, configured to calculate said ticket using said physical mark and a one-way function, configured to calculate a receiver dependent ticket using said ticket, said unique receiver identifier, and said one-way function, and configured to provide to a receiver a data stream containing said watermarked content, said ticket, and said receiver dependent ticket.

18. The system of claim 17, wherein said one-way function is a hashing function.

19. A display device for receiving data containing watermarked content and a ticket, wherein said ticket and watermark together indicate a copy protection status of the content, said display device comprising:
a memory configured to store a unique receiver identifier; and
a processor, wherein if said checkpoint is contained within a time window determined by said current time reference, said processor is configured to:
receive a receiver dependent ticket and said data,
combine said ticket with said unique receiver identifier to produce a first result,
perform a one-way function on said first result to produce a second result, and
compare said second result to said receiver dependent ticket, wherein said display device is further configured to display said data if said second results compares to said time dependent ticket.

20. The system of claim 19, wherein said one-way function is a hashing function.
